(19) United States
(12) Patent Application Publication
(10) Pub. No.: US 2001/0048676 A1
(43) Pub. Date: Dec. 6, 2001

(54) Methods and apparatus for executing an audio attachment using an audio web retrieval telephone system

(76) Inventors: Ray Jimenez, Carlisle, MA (US); Donald Picard, Somerville, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/755,710

(22) Filed: Jan. 5, 2001

Related U.S. Application Data
(60) Provisional application No. 60/175,034, filed on Jan. 7, 2000.
(60) Provisional application No. 60/195,645, filed on Apr. 7, 2000.
(60) Provisional application No. 60/195,737, filed on Apr. 7, 2000.

(51) Int. Cl. H04L 12/66; H04L 12/28; H04L 12/56

(52) U.S. Cl. 370/352; 370/400; 709/219

(57) ABSTRACT

In one aspect the invention relates to a method for retrieving an audio application attachment to an electronic mail message (“email”). The method includes establishing a telephone call with a user connecting to an audio web telephone system using a telephony device, processing a command from the user to enable the user to retrieve an email from a buffer location accessible to the audio web telephone system and detecting an audio application attachment to the email. The method further includes passing the audio application attachment to an audio browser, executing the audio application attachment by processing Voice XML code within the audio application attachment and generating an audio message. The method further includes providing the audio message to the user via the telephony device.

### CROSS-REFERENCE TO RELATED APPLICATIONS

This application claims priority to U.S. provisional applications Ser. No. 60/175,034, filed Jan. 7, 2000, Ser. No. 60/195,645, filed Apr. 7, 2000 and Ser. No. 60/195,737, filed Apr. 7, 2000. These co-pending applications are incorporated herein by reference in their entirety.

### FIELD OF THE INVENTION

In general, the technology described herein relates to the dissemination of web audio information. More particularly, the technology relates to the identification, qualification, organization and formatting of web audio information for access and navigation from a wireless or wireline telephone. The technology also relates to methods for retrieving audio application attachments to emails and web content, and methods for forwarding audio content to email addresses and other web telephone subscribers.

### BACKGROUND OF THE INVENTION

Referring to FIG. 1, telecommunications carriers utilize one or more traditional voice application servers 4 within the public switched telephone network (“PSTN”) 8 to handle various call processing functions. Wireless 12 and wireline 16 telephones are connected to the voice application server 4 via the PSTN 8. The voice application server 4 is a combination of hardware (e.g., D/A, A/D and DTMF circuitry) and software (e.g., voice application processing) that performs call processing operations, administration, maintenance and provisioning functions. The voice application server 4 selectively accesses a subscriber database 20 and message database 24 while handling call flow and call processing functions.

Historically, telecommunications carriers have experienced various problems in servicing, maintaining and upgrading voice application servers 4. For example, each voice application server 4 in a network (not shown) is typically maintained and serviced separately from other voice application servers 4′ (not shown). In addition, the time frame for implementing and deploying new features in a voice application server 4 is on the order of four years. Also, the location of each voice application server 4 and the length of the T1/E1 lines (not shown) within a network must be carefully balanced by the telecommunications carrier.

### SUMMARY OF THE INVENTION

This invention relates to an architecture that uses a telephony interface module that serves as a Quality of Service (“QoS”) telephony packet protocol (e.g., SIP, H.323) endpoint to a call over the public switched telephone network (“PSTN”). The telephony interface module is in communication with resources over a network (e.g. LAN/WAN) using the standard Internet protocol (“IP”). This allows any other resources in communication with the IP network to be used. The resources perform certain functions that support the dissemination of web audio information, including 1) translating the signal into user-desired commands and 2) carrying out desired actions of the user. Some desired actions can be, for example, retrieving documents (e.g., HTML, XML, VXML) and streamed audio signals from the Internet, executing audio applications and/or forwarding portions of a retrieved audio signal to someone else. Applications can be executed on servers that are external to the telephony interface module. The telephony interface module receives audio signals from the resources in communication with the IP network and converts those audio signals to an audio signal conforming to a QoS telephony packet protocol to transmit the signal to a user of a telephony device in communication with the PSTN.

The invention has robust call control including redundancy, failover, and high availability features. Each component in the invention performs a discrete and independent function that can be and is replicated in the preferred embodiment. The Telephony Gateway is configured to route traffic to a multiplicity of Telephony Interface Modules in case a particular module is not responding or has reached capacity. Furthermore, each Telephony Interface Module is configured to route traffic to a multiplicity of VXML Browser modules in case a particular module is not responding or has reached capacity. The same is true of the Navigation Modules, Content Retrieval Modules, and optional Web Caching modules, and other components that comprise the system. Finally, for added availability of the network service, the PSTN can be configured to route traffic to a multiplicity of telephony gateways should a gateway not respond or has reached capacity. Since the application service offered to the caller is retrieved via VoiceXML over an IP network, any and all instances of the system will process the call in the same manner, and therefore provide the desired service to the caller.

In one aspect the invention relates to a method for retrieving an audio application attachment to an electronic mail message (“email”). The method includes establishing a telephone call with a user connecting to an audio web telephone system using a telephony device, processing a command from the user to enable the user to retrieve an email from a buffer location accessible to the audio web telephone system and detecting an audio application attachment to the email. The method further includes passing the audio application attachment to an audio browser, executing the audio application attachment by processing Voice XML code within the audio application attachment and generating an audio message. The method further includes providing the audio message to the user via the telephony device. In one embodiment, the phone call is established by the user calling the system. In another embodiment, the phone call is established by the system calling the user.

In another embodiment, the method includes identifying a sender of the email having the audio application attachment prior to executing the Voice XML statements of the attachment. In another embodiment, the step of identifying further comprises reviewing a list of senders. In another embodiment, the method includes requesting the user's permission prior to executing the audio application attachment. In another embodiment, the method includes providing a profile of the user to a sender of the email. In another embodiment, the step of establishing a phone call further comprises, receiving a circuit-switched signal from the telephony device used by the user over a public switched telephone network (“PSTN”), converting the circuit-switched signal to a telephony packet protocol signal including an audio portion, converting the telephony packet protocol signal to an Internet protocol (“IP”) packet signal including an audio portion, converting the audio portion of the IP packet signal to a text equivalent signal and converting the text equivalent signal to an IP network command signal.

In another aspect, the invention relates to a method of retrieving an audio application attachment from a web-based document. The method includes establishing a telephone call from a user of an audio web telephone system using a telephony device to request access to a web-based document, determining an audio application attachment to the web-based document, transmitting the audio application attachment to an audio browser, executing the audio application attachment by processing the Voice XML code within the audio application and generating an audio message, and providing the audio message to the user via the telephony device. In one embodiment, the phone call is established by the user calling the system. In another embodiment, the phone call is established by the system calling the user.

In another embodiment, the step of establishing a phone call further comprises, receiving a circuit-switched signal from a telephony device used by the user over a public switched telephone network (“PSTN”), converting the circuit-switched signal to a telephony packet protocol signal including an audio portion, converting the telephony packet protocol signal to an Internet protocol (“IP”) packet signal including an audio portion, converting the audio portion of the IP packet signal to a text equivalent signal and converting the text equivalent signal to an IP network command signal.

In another aspect, the invention relates to an audio web telephone system for retrieving an audio application attachment from an electronic mail message (“email”) or from a web-based document. The system includes a telephony gateway in communication with a public switched telephone network (“PSTN”), the telephony gateway configured to receive a telephone call from a user using a telephony device; an Internet protocol (“IP”) network. The system further includes an audio browser. The audio browser includes a content retrieval module in communication with the IP network, the content retrieval module configured to detect an audio application attachment from one of an email and a web-based document. The audio browser also includes a VXML browser in communication with the IP network, the VXML browser configured to execute the audio application attachment by processing Voice XML code within the audio application attachment and generating an audio message. The audio browser also includes a telephony interface module in communication with the telephony gateway for communicating with a telephony device of the user and in communication with an IP network to receive the audio message, the telephony interface configured to translate an IP based signal of the audio message to a telephony packet-based signal of the audio message, thereby providing the audio message to the user via the telephony device.

In one embodiment, the system includes an authentication module in communication with the IP network, the authentication module having a list of trusted senders. In another embodiment, the system includes web cache. In another embodiment, the audio browser further comprises a navigation module. In another embodiment, the navigation module further comprises one of speech recognition module and touch tone (DTMF) recognition module. In another embodiment, the content retrieval module includes a text-to-speech module, a streaming media module or both.

### BRIEF DESCRIPTION OF THE DRAWINGS

FIG. 1 is a simplified block diagram showing a traditional voice application server within the public switched telephone network (PSTN) known in the prior art;

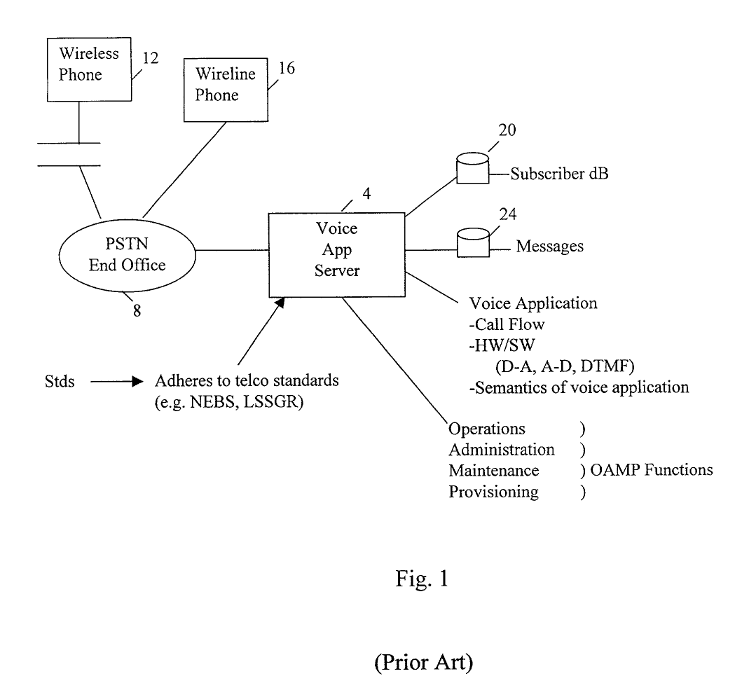

FIG. 2 is a simplified block diagram showing the architecture of an audio web telephone system according to the invention;

FIG. 3a is a simplified block diagram showing the details of an embodiment of an audio browser for the architecture of an audio web telephone system according to the invention;

FIG. 3b is a simplified block diagram showing the details of another embodiment of an audio browser for the architecture of an audio web telephone system according to the invention;

FIG. 3c is a simplified block diagram showing the details of an audio browser in communication with a third generation wireless device for the architecture of an audio web telephone system according to the invention;

FIG. 3d is a simplified block diagram showing the distributed nature and scalability of the audio web telephone system architecture according to the invention;

FIG. 4 is a simplified block diagram showing an audio web telephone system for retrieving audio application attachments to emails according to the invention;

FIG. 5 is a simplified block diagram showing an audio web telephone system for retrieving audio application attachments to web content according to the invention;

FIG. 6 is a simplified flow diagram showing an audio web telephone method for forwarding audio content to a telephone subscriber or Internet addressee according to the invention.

### DETAILED DESCRIPTION OF THE TECHNOLOGY

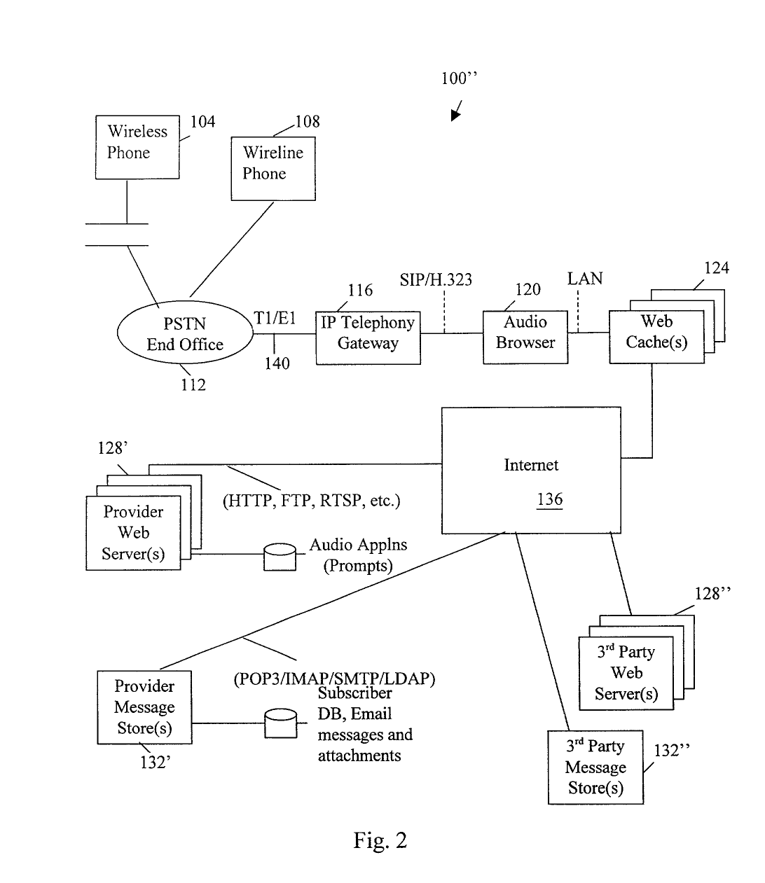

FIG. 2 is a block diagram showing an audio web telephone system 100 that enables a user (also referred to as a subscriber) of a telephony device (e.g., wireless 104 phone, wireline 108 phone, speaker phone or any other telephony device configured to connect to the PSTN) to access and navigate audio information via an Internet protocol (“IP”) network 136 (e.g., the Internet, the World Wide Web, a company intranet). The user's audio inputs are converted by the system 100 to an action to be performed on the IP network 136. The action is to retrieve information, generally referred to as a document, from a device connected to the IP network 136. A document can be a HTML page, a voice XML page, or some other type of file containing data (e.g., text, audio, multimedia, etc.) the system 100 retrieves, converts to audio output and plays to the user on the telephony device.

As shown, the system 100 is connected to a PSTN 112 end office and includes a telephony gateway 116, an audio browser 120 and multiple web 128′, 128″ (generally 128) and messaging servers 132′, 132″ (generally 132). Also shown in the embodiment depicted in FIG. 2 is an optional web cache 124 to buffer retrieved information or heavily accessed information to expedite and optimize service to the user. The telephony gateway 116, web cache(s) 124, and web 128 and messaging 132 servers can be off-the-shelf devices. For example, the telephony gateway 116 can be a CISCO 3600 series router. The web cache 124 can be an off-the-shelf Internet caching appliance (e.g. Internet caching appliances developed by CacheFlow, Inc.) and the servers 128, 132 can be an off-the-shelf Internet server (e.g. Compaq Proliant DL 360).

In one embodiment, the telephony gateway 116, audio browser 120, and web cache(s) 124 are located in or near the PSTN 112 end office. The telephony gateway 116 is connected to the PSTN 112 via a T1/E1 line 140 and converts circuit-switched telephone calls into packet switched calls based on a telephony packet protocol (e.g., SIP, H.323). In one implementation, the telephony gateway 116 is an off-the-shelf unit that conforms to the H.323 standard (e.g., CISCO 3600 Series Routers). The telephony gateway 116 outputs the H.323 data that is received by the audio browser 120. The audio browser 120 acts as an H.323 endpoint.

The audio browser 120 executes special purpose software that adheres to the proposed Voice XML standard. A telephone user may choose to listen to the set of audio web sites that were pre-configured by the user via a traditional web browser or via alternate web interfaces such as a WAP enabled wireless handset or palmtop microbrowser. A telephone user may also navigate through various audio sites available on the World Wide Web 136 using the audio browser 120 in a manner similar to a typical Internet browser. The audio browser 120 can use Text-To-Speech (TTS) software to convert text (e.g. news feeds, email, HTML documents) from the web to audio for the caller.

In addition, the audio browser 120 is responsive to DTMF commands and handles various call processing functions such as Answer, Release, Dial, OutCall, GetDTMF, Play, Record, Say (TTS), FAX Recv, Fax Send. The audio browser 120 can also be responsive to spoken commands, handling the various call processing functions using commercially available speech recognition software.

The audio browser 120 also receives data from the web cache 124. The web cache 124 can be off-the-shelf hardware and software (e.g., CacheFlow, Inktomi and/or Real Networks, for caching RealAudio media over a wide area network, such as the World Wide Web). For improved connection time characteristics when managing cache data over a local area network (LAN), customized software can be written using a standard http protocol. The web cache 124 may be used in a completely reactive manner (e.g., caching data that is requested often from various callers) or it may be used to cache data that is known ahead of time to be of value to callers (e.g., audio prompts or other audio sources). The Internet Caching Protocol (ICP) is one technology that may be used to cache data in advance of its use.

The audio browser 120 accesses the web 128 and message servers 132 (e.g., for email messages with audio, fax, text, and other media attachments) via the World Wide Web 136 to retrieve web multi-media content and provide it to a telephone user in real time. A user manipulates the audio browser 120 to select, organize and navigate through a variety of audio sites. The sites can be organized and customized for each user. The organization and/or customization of the user's sites are stored in a database accessible by a web server 128. When a user selects a particular audio site, the audio web browser 120 connects to the desired site via the web cache 124. In another embodiment, if there is no web cache 124, the audio browser 120 handles the process directly. The web cache 124 either provides the content directly to the audio browser 120, or connects to the remote site to retrieve the data for both the audio browser 120 and itself 124. Once connected, the audio web browser 120 provides the audio content (e.g., audio signal) to the telephone user.

The audio web telephone system 100 can include a “prefetch” capability to minimize delays. When a telephone user dials into the system, the web server 128 sends the URLs of the user to the audio browser 120. While the user hears the system greeting, or other readily accessible audio data, the audio browser 120 prefetches and buffers the remote audio content located at the selected audio sites. This prefetch can also be done based on the demands of multiple users. For example, if web site A (not shown) serves up an audio news feed at 2 p.m. Eastern U.S. time every day and 10,000 subscribers all have configured their audio web to receive that feed, then the system can be configured to retrieve that feed as soon as it becomes available, as opposed to waiting until each individual telephone user logs into the system 100.

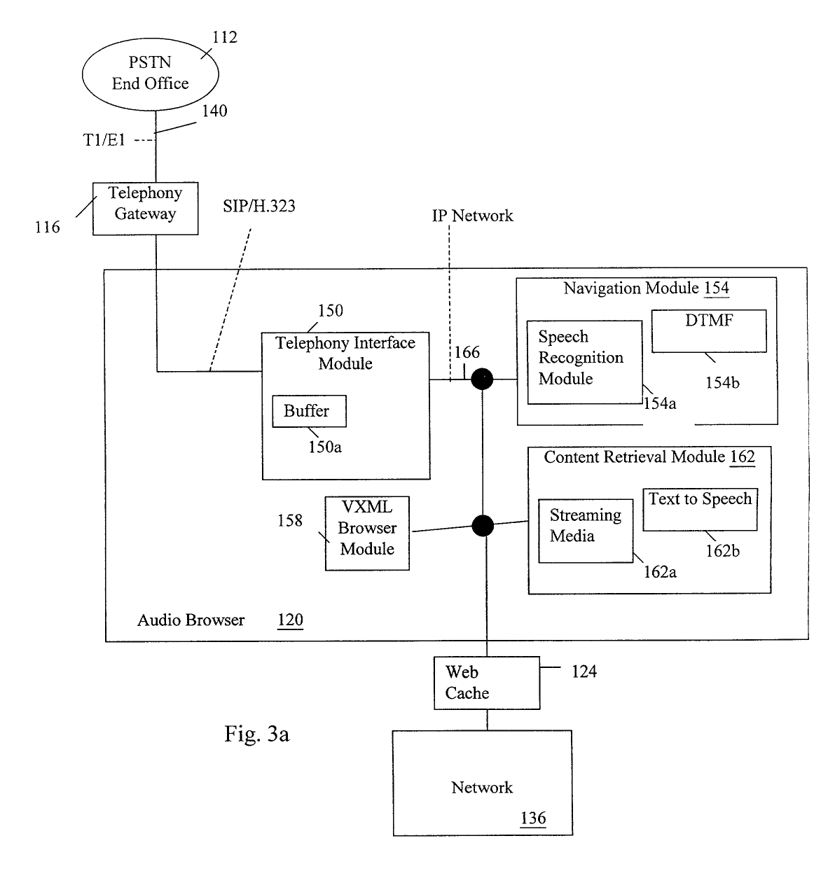

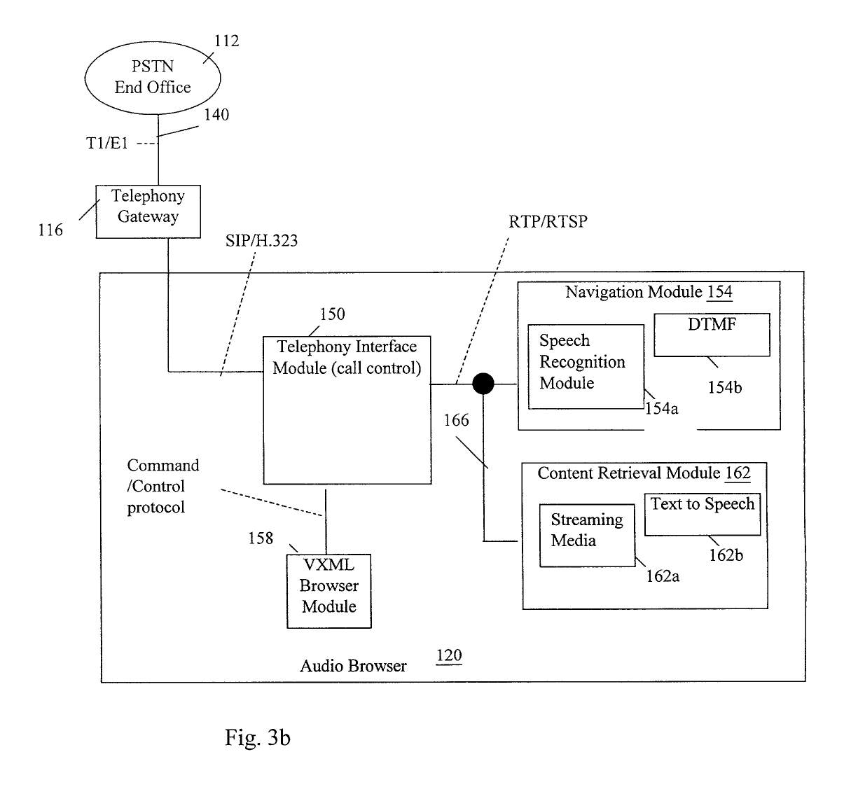

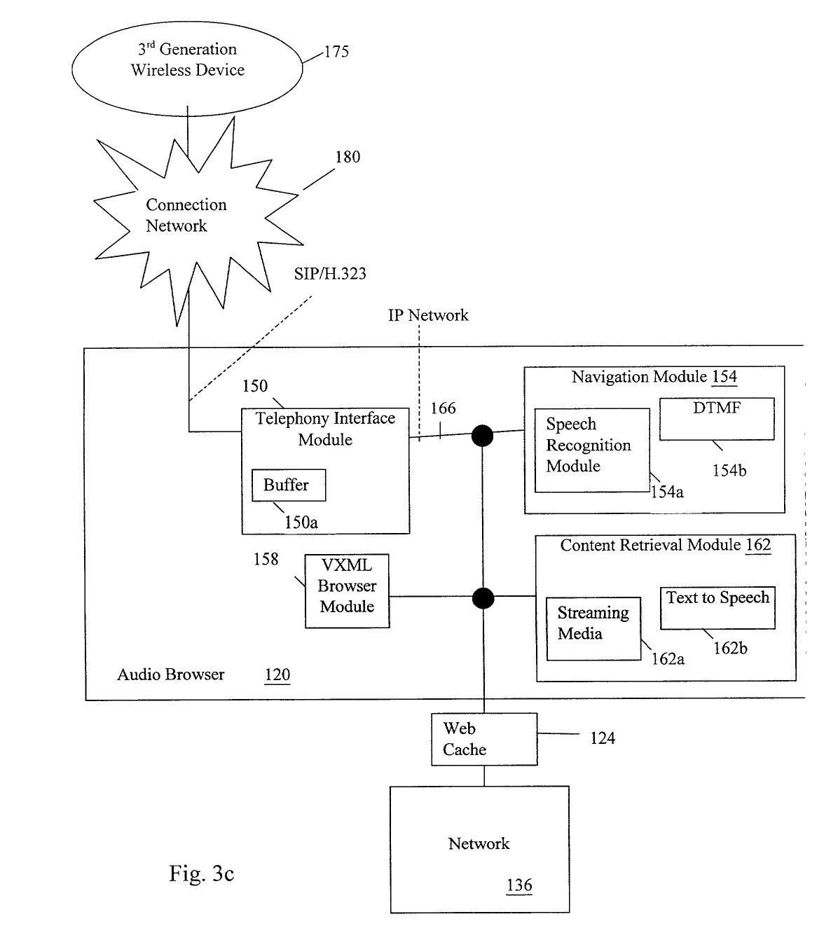

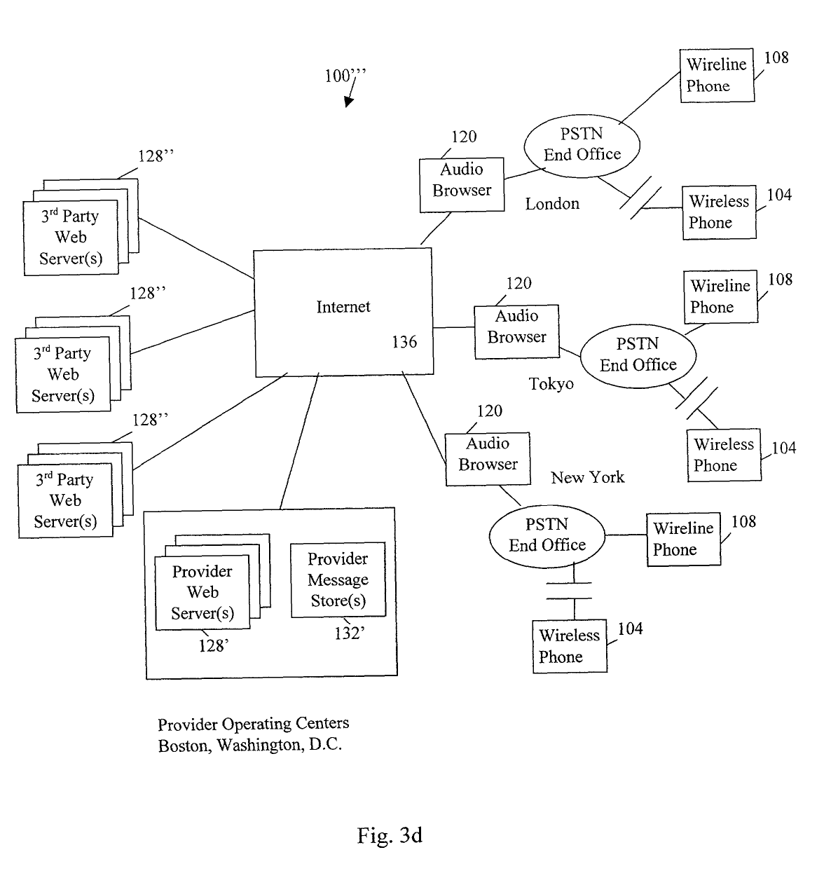

FIGS. 3a, 3b and 3c depict detailed embodiments of the audio browser 120. The audio browser 120 includes a telephony interface module 150, a navigation module 154, a Voice XML module 158 and a content retrieval module 162. The telephony interface module 150 includes a buffer 150a. The telephony interface module 150 serves as an H.323 endpoint and communicates with the telephony gateway 116. The navigation module 154 includes a speech recognition module 154a and a DTMF recognition module 154b. The content retrieval module 162 includes a streaming media module 162a and a text to speech module 162b.

The modules 150, 154, 158, 162 are in communication with each other over an IP network 166 (e.g., LAN, WAN, intranet). The IP network 166 is in communication with an external IP network 136 (e.g., another intranet, the Internet, LAN, WAN) through web cache 124. The modules 150, 154, 158, 162 represent logical connections and not necessarily physical partitions of each of the components. The modules may all be located on the same server (e.g., a server represented by the audio browser 120) or located on different servers (e.g., servers represented by each of the modules 150, 154, 158, 162). In another embodiment, the telephony interface module 150 can be located within the telephony gateway 116.

As shown in FIG. 3a, the audio browser 120 is connected to the telephony gateway 116. More specifically, the telephony interface module 150 is in communication with the telephony gateway 116. For an incoming call, the telephony interface module 150 receives, from the telephony gateway 116, a telephony packet protocol signal (e.g., SIP, H.323). The telephony packet protocol signal includes an audio portion containing the spoken words of the user on the telephony device (e.g., wireless 104 or wireline 108 phone) or a DTMF signal. The telephony interface module 150 routes this signal (i.e., the packets with the audio portion) according to a command.

The telephony interface module 150 accepts commands from other modules (e.g., 154, 158, 162) in communication (e.g., via the IP network 166) with the telephony interface module 150 using any IP protocol (e.g., http). Examples of the commands accepted by the telephony interface module 150 are listed in Table 1. Since the telephony interface module 150 communicates with the other modules (e.g., 154, 158, 162) using a standard protocol and then buffers the data in the buffer 150b to send out to the telephony gateway 116 using a telephony packet protocol, almost any resource available on the IP network 166 or IP network 136 can be utilized and/or communicated to the user. The telephony interface module 150 is an endpoint that applications can communicate with using existing IP network protocols. In other words, developers can use applications to interact with the telephony interface module 150 (i.e., endpoint) without modifying the applications for a telephony packet protocol, as the telephony interface module 150 handles that aspect of the communication process.

TABLE 1

| Command | Parameter(s) | Description |
|---|---|---|
| ANSWER | | This command creates a |
| | | connection between the user |
| | | and the audio browser 120. |
| | | This command obtains |
| | | information (e.g., the name of |
| | | the user, the calling party phone |
| | | number, and the called party |
| | | phone number) about the |
| | | connection. |
| RELEASE | | This command terminates the |
| | | connection between the user and |
| | | the audio browser 120. |
| CALLINFO | <session identifier> | This command obtains |
| | | information (e.g., the name of |
| | | the user, the calling party phone |
| | | number, and the called party |
| | | phone number) about the |
| | | connection between the user and |
| | | the audio browser 120. |
| GETINPUT | <initial time-out | This command notifies the |
| | duration, inter-digit | telephony interface module 150 |
| | time-out duration, | that an audio input (e.g., voice |
| | maximum number | or DTMF) is needed from the |
| | of DTMF digits, | user. The command will wait up |
| | terminating DTMF | to the initial time-out value for |
| | digits> | input. If a DTMF digit is |
| | | received, the command will |
| | | obtain the digits entered by the |
| | | user until the inter-digit |
| | | time-out is reached, the |
| | | maximum number of digits is |
| | | reached, or a terminating digit |
| | | is obtained. |
| SAY | <URL, text, size, | This command speaks text (i.e., |
| | type, SYNC flag, | creates an audio file from text) |
| | BREAK flag> | to the user, using a |
| | | text-to-speech converter, in one |
| | | embodiment, located in the |
| | | content retrieval module 162. |
| | | The command obtains the text |
| | | from a file indicated by the |
| | | URL, from the text parameter, |
| | | or from text following the |
| | | command of the size specified. |
| | | If the SYNC flag is specified, |
| | | the audio file will be played |
| | | synchronously (e.g., the |
| | | command will not complete until |
| | | the audio has finished playing). |
| | | If the BREAK flag is specified, |
| | | the audio will stop playing when |
| | | a subsequent command is |
| | | received. |
| RECORD | <URL, encoding, | This command records the |
| | maximum duration, | spoken words of the user to an |
| | maximum silence, | audio file saved in the location |
| | terminating DTMF | indicated by the URL to be |
| | digits, BEEP flag> | retrieved in the future, located |
| | | on a web server 128. The audio |
| | | file will be created in the |
| | | encoding format specified. The |
| | | recording will terminate when |
| | | the maximum duration is |
| | | reached, the maximum |
| | | continuous silence is reached, |
| | | or the user presses a terminating |
| | | DTMF digit. If the BEEP flag is |
| | | specified, an audio tone will be |
| | | played to the user to mark the |
| | | start of recording. |
| PLAY | <URL, SYNC flag, | This command obtains the audio |
| | BREAK flag> | file indicated by the URL and |
| | | plays the audio file to the user, |
| | | using the appropriate player, in |
| | | one embodiment, located in the |
| | | content retrieval module 162. If |
| | | the SYNC flag is specified, the |
| | | audio file will be played |
| | | synchronously (e.g., the |
| | | command will not complete until |
| | | the audio has finished playing). |
| | | If the BREAK flag is specified, |
| | | the audio will stop playing when |
| | | a subsequent command is |
| | | received. |
| SETGRAMMAR | <URL, grammar> | This command notifies the |
| | | navigation module 154 of the |
| | | possible responses the user can |
| | | give. The command obtains the |
| | | file containing the possible |
| | | responses indicated by the URL, |
| | | in one embodiment, located on a |
| | | web server 128 or a list of |
| | | possible responses. |
| FLUSHDTMF | | This command notifies the |
| | | telephony interface module 150 |
| | | that any pending DTMF digits |
| | | should be removed from the |
| | | DTMF module 154b. |
| GETDTMF | <initial time-out | This command notifies the |
| | duration, inter-digit | telephony interface module 150 |
| | time-out duration, | that DTMF input is needed from |
| | maximum number | the user. The command will wait |
| | of DTMF digits, | up to the initial time-out value |
| | terminating DTMF | for input. If a DTMF digit is |
| | digits> | received, the command will |
| | | obtain the digits entered by the |
| | | user until the inter-digit time-out |
| | | is reached, the maximum |
| | | number of digits is reached, or a |
| | | terminating digit is obtained. |
| DELETE | <URL> | This command removes an audio |
| | | file saved in the location |
| | | indicated by the URL, in one |
| | | embodiment located in the |
| | | content retrieval module 162. |
| DELAY | <duration, | This command plays silence to |
| | terminating DTMF | the user for the duration |
| | digits, SYNC flag, | specified. If the SYNC flag is |
| | BREAK flag> | specified, the silence will be |
| | | played synchronously (e.g., the |
| | | command will not complete until |
| | | the duration has completed). If |
| | | the BREAK flag is specified, the |
| | | silence will stop playing when a |
| | | subsequent command is |
| | | received. |

The buffer 150a is used to store the audio data to be supplied to the user. The telephony interface module 150 receives the audio data using any standard IP. The telephony interface module 150 transmits the audio information stored in the buffer to the telephony gateway 116 using a QoS telephony packet protocol. While performing a requested function for the user that could entail retrieval latency, the system 100 preloads audio information into the buffer 1 50a of the telephony interface module 150 to transmit to the user. As such, the system 100 does not force the user to wait in silence while carrying out the requested function. The preloaded audio information can vary. For example, the audio information may be a simple message that the request is being fulfilled and the data requested will arrive in a determined time interval. As other examples, the audio information can be advertisements or new feature announcements.

In an example transaction, a user has requested to hear to a National Public Radio (“NPR”) broadcast that is available on the Internet 136. The VXML page being executed by the VXML browser module 158 has a URL (e.g., http://www.nrp.org/daily.ra) as the audio source corresponding to the NPR selection. The VXML browser module 158 transmits this URL as a PLAY URL−“http://www.nrp.org/daily.ra” command to the telephony interface module 150. The telephony interface module 150 sends the URL to the web cache 124 with a request to retrieve and play that file to the telephony interface module 150. The web cache 124 determines whether the requested audio feed is already stored in the web cache 124. If not, the web cache, using HTTP, performs a head inquiry on the URL to determine the type. After receiving a response that the type is a streamed audio signal using a Real Network codec, the web cache 124 sends a request to the content retrieval module 162 to launch a Real player (e.g., illustrated as a streaming media module 162a) using the URL as the source file. The audio stream is retrieved by the telephony interface module 150 and is transmitted to the telephony gateway 116, as the audio stream is received from the source, using the telephony packet protocol (e.g., H.323) so that the telephony gateway can send the audio signal to the user over the PSTN 112. The telephony interface module 150 continues transmitting the audio signal to the telephony gateway 116 in the manner described above until the end of the audio stream is reached.

FIG. 3b illustrates another embodiment of the details of the audio browser 120. The depicted embodiment contains the same modules 150, 154, 158 162 as the embodiment of FIG. 3a. The difference is the communication channels between modules and the telephony gateway 116 are arranged differently. The protocols used are indicated on each of the communication channels of FIG. 3b.

FIG. 3c illustrates the audio browser 120 connected to a third generation wireless device 175. The third generation wireless device 175 uses a telephony packet protocol and is therefore in communication with the telephony interface module 150 of the audio browser 120 through a connection network infrastructure 180. In this embodiment, the telephony gateway 150 is not needed, because the signals from the third generation wireless device 175 are packet based. The telephony interface module 150 only needs to coordinate transmission of packets to and from the third generation wireless device 175. The embodiment illustrated in FIG. 3b also supports a third generation phone by similarly replacing the telephony gateway 116 and the PSTN end office 112 with a connection network 180 and a third generation wireless device 175.

FIG. 3d depicts a system 100′″, in which several audio browsers 120 are located throughout the world (e.g., New York, London, Tokyo) to provide audio access to subscribers no matter where they are located. Since the audio browser 120 is IP based and performs discrete functions independent of the application or service being offered to the caller, as well as independent of other audio browsers, the system 100′″ is scalable to essentially any size. Each audio browser 120 is capable of performing the function of any other audio browser 120 as part of the network of audio browsers comprising the system 100′″. In this embodiment, the telephony gateway 116 is included in the audio browser 120.

Since the audio web telephone system 100 architecture contains a telephony interface module 150 (i.e., a telephony endpoint), the system 100 can perform some unique functions. For example, the audio web telephone system 100 can also be used to retrieve audio application attachments. Audio application attachments refer to any application attachments that can be transferred into voice. Audio application attachments are based on Voice XML. Audio application attachments can perform any function that the sender or provider desires, primarily because Voice XML has access to the breadth of the Internet via the URL mechanism inherent in the Voice XML “goto” tag. For example, an email audio application attachment can perform an audio survey to poll the subscriber for information. An audio application attachment to a web content can also be used to contract business with subscribers of the audio web telephone system. In another example, the audio attachment can search the sender's database for related topics in which the subscriber has an interest. In another example, if the application was attached to an email from an auction web site informing the subscriber a higher bid has been offered, the application can prompt the subscriber, asking if the subscriber wishes to increase his or her bid. If the subscriber answers in the affirmative, the application obtains the new bid from the subscriber and completes the transaction with the new information, not requiring any additional steps from the subscriber. In another example, the application can obtain personalized weather information for the subscriber, either by prompting the subscriber for the desired location and then retrieving the information from the World Wide Web or by obtaining the predefined information about the subscriber from the system and automatically retrieving the information.

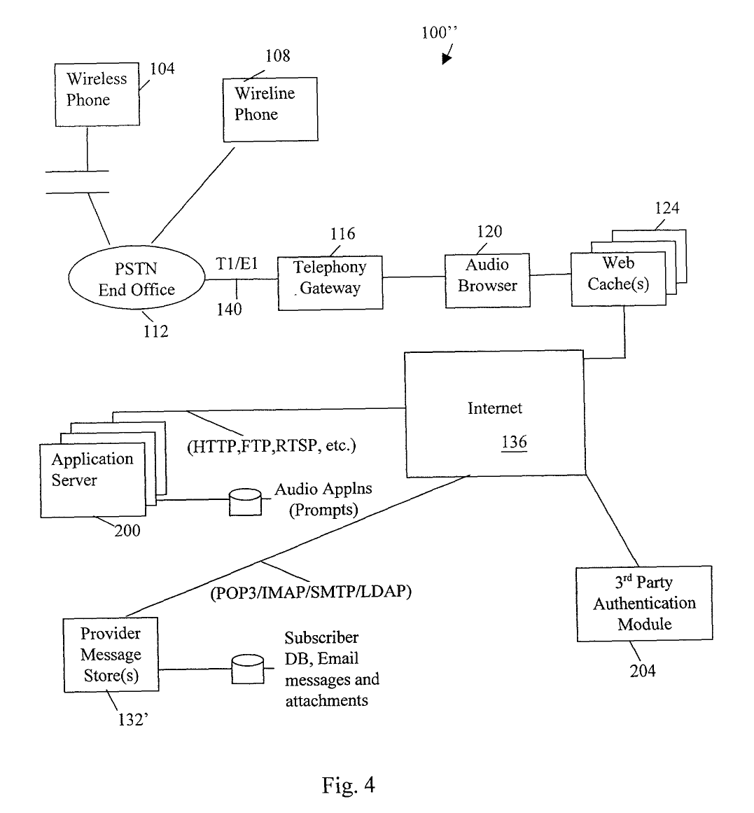

FIG. 4 illustrates an audio web telephone system 100″ for retrieving audio application attachments to email messages. Examples of audio application attachments to emails include, but are not limited to, voice attachments, voice mail, and fax messages transformed into voice through optical character recognition. The system 100″ includes an application server 200 and a third party authentication module 204. Both the application server 200 and the third party authentication module 204 are in communication with the rest of the system components via an IP network 136 (e.g., Internet).

An audio application attachment to an email can be retrieved as follows. A subscriber of the audio web telephone system 100″ calls in to check the subscriber's email messages. The application server 200 generates Voice XML for each message in the subscriber's mailbox and plays each message. The application server 200 also detects whether a message about to be played contains an audio application attachment executable by a Voice XML compatible browser. Audio application attachments executable by a Voice XML browser will be referred to herein as Voice XML attachments. The application server 200 passes the Voice XML attachments to the audio browser 120. The audio browser 120 executes the Voice XML statements contained in the attachment and the subscriber hears the messages in the Voice XML attachments.

In one embodiment, an identity of the sender of the message is verified prior to execution of the Voice XML attachment. The verification can be completed in number of different ways. The verification can be done using a third party authentication module 204 in communication with the IP network 136. The identity of the sender can be verified through encrypted digital signature or by looking up a list of pre-assigned trusted senders. Upon verification of the sender, the audio browser can execute the attachment. In another embodiment, the audio browser 120 requests for the subscriber's permission prior to executing the attachment. If the subscriber approves, the audio browser 120 executes the attachment by interpreting its Voice XML statements. Alternatively, the audio browser 120 can automatically execute audio attachments from a sender on a list of trusted senders. The application server 200 can also know that certain senders are not to be trusted and their attachments never executed.

The audio browser 120 can optionally allow the profile of the subscriber to be provided to the sender or provider of the audio attachment. For example, a subscriber may be listening to the Wall Street Journal Hourly Update, which is freely available through the audio web system 100. A Voice XML application can be attached to the audio feed of the Wall Street Journal Hourly Update. The Voice XML application, for example, would state:

Thank you for listening to this Hourly Update brought to you by the Wall Street Journal. The complete Wall Street Journal audio edition is available to you on your XXX for just $xx.99 per month. To subscribe, press 1 or say “subscribe now.” To receive more information about the Wall Street Journal audio edition, press 2 or say “more information” now.

If the subscriber of the audio web system decides to subscribe to the Wall Street Journal, information about the subscriber is forwarded to the Wall Street Journal to fulfill the subscription.

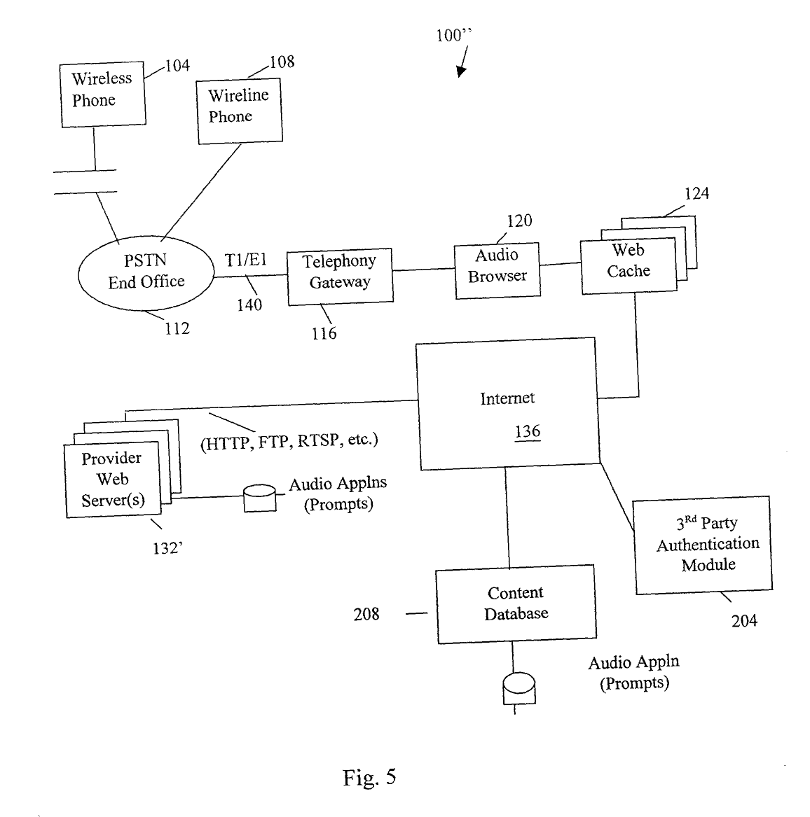

In another embodiment, FIG. 5 illustrates an audio web telephone system 100′″ for retrieving audio application attachments from an audio or text feed (i.e., web content) contained on a content database 208 in communication with an IP network 136. This web content can be raw audio, text, or Voice XML applications. This web content can include audio attachments. An example of an audio feed is National Public Radio (NPR) broadcast available on the Internet 136. Certain web content can be pre-qualified and made available to the subscribers of the audio web telephone system 100″′. The subscriber can select a web content from the content database 208 containing pre-qualified content. The Application Server 200 (FIG. 4) is aware of whether the selected pre-qualified content includes a Voice XML application ahead of time. Thus, the Voice XML application is automatically executed. Other content may be obtained through custom link. For example, the subscriber may request to listen to a radio station from a remote location. In this case, the Application Server 200 does not know whether the content includes a Voice XML attachment. The Application Server 200 must connect to the content source via http or similar mechanism to determine whether the content includes a Voice XML application first. Thereafter, if the content includes a Voice XML application, the Voice XML application can be executed by the audio browser 120 and provided to the subscriber. Optionally, the identity of the content source can be verified to determine whether it is a trusted source. The Voice XML applications are executed and provided to the subscriber as described in reference to FIG. 4.

As described above, the subscriber can listen to audio content from many different sources. For example, a subscriber can be listening to audio content that is accessible from the Internet 136, either as email messages (unified messaging), as audio or text content feeds or as audio applications. While the subscriber is listening to the audio content, the subscriber has the ability to instruct the system to forward this audio content, or the executing audio application that is producing this audio content, on to other email addresses. If an audio application is forwarded, the audio application re-executes when the recipient accesses the audio application. In other words, the recipient can interact with the executing application, not just hear how the subscriber had interacted with the application.

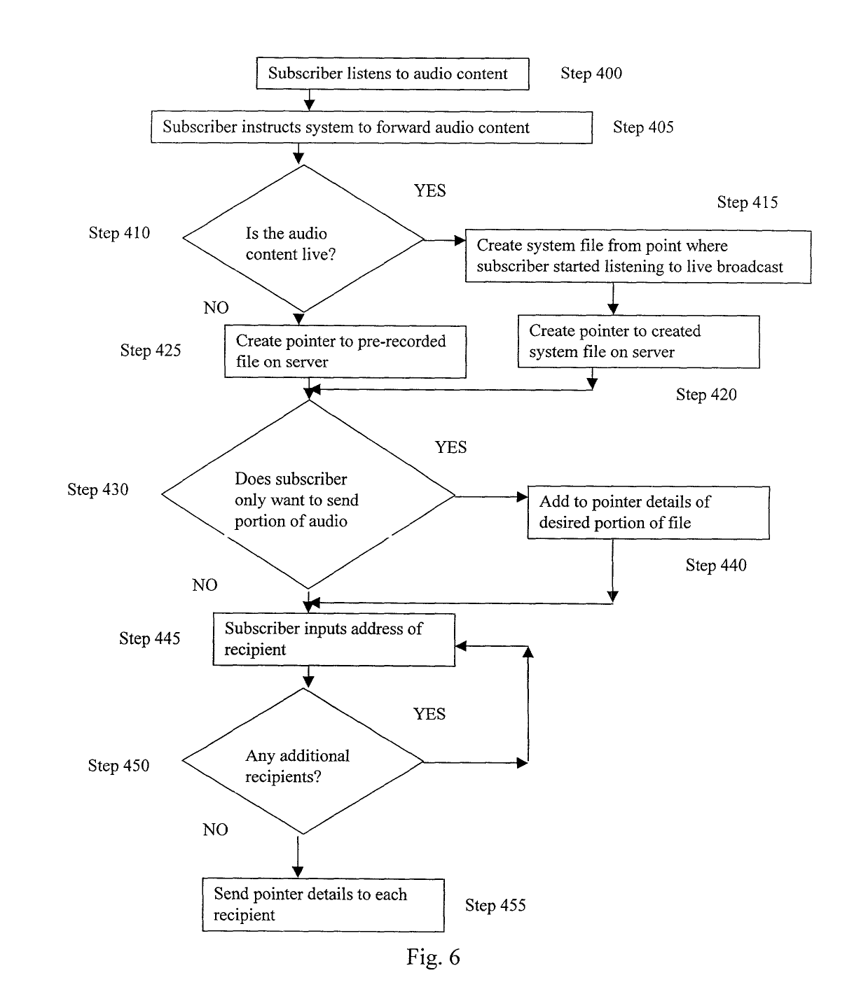

In more detail, FIG. 6 depicts one embodiment of the process of forwarding the audio content to one or more recipients. While the subscriber is listening to the audio content (step 400), the subscriber decides to forward the audio content. The subscriber instructs the system 100 to forward the audio content (step 405). In one embodiment the step of instructing the system to forward the audio content (step 405) can be implemented using spoken commands or DTMF tones.

Once the system 100 recognizes the instruction, the system 100 determines whether the audio content is from a live feed (step 410). If the audio content is coming from a live feed, the system 100 creates an audio content file that contains the portion of the live feed starting from where the subscriber started listening and ending where the subscriber gave the instruction to forward (step 415). In one embodiment, the system 100 copies the audio content from the web cache 124 to a more permanent storage facility on the web 128 (FIG. 2) and messaging 132 (FIG. 2) servers. The system 100 creates a reference pointer (e.g., URL) to this audio content file (step 420). If the audio content the subscriber is listening to is not live, then a file already exits. The system 100 creates a reference pointer (e.g., URL) to this existing audio content file (step 425).

The system 100 determines whether the subscriber wants to send the entire audio content or just a portion of the audio content (step 430). For example, the subscriber listening to an audio content for the last 30 minutes may only want to send the portion the subscriber listened to for the 5 minutes preceding the instruction to forward. In one embodiment, the system 100 can offer the subscriber a menu of choices of portions and have the subscriber select a choice using either spoken commands or DTMF tones. If the subscriber does want to forward only a portion of the audio content, the system 100 changes the reference pointer (e.g., URL) accordingly (step 440). In one embodiment, the system can create a new file containing only the forwarded portion. In another embodiment, the system changes the reference pointer to the storage location where the forwarded portion begins.

Once the reference pointer is established, the system prompts the subscriber for an address of the recipient. The subscriber inputs the email address via touch-tone (the system interprets using the DTMF module 154b), speech recognition (the system interprets using the speech recognition module 154a), or WAP interface (step 445). In another embodiment, an alias can be used that represents an address that has already been input via the Web interface into the subscriber's personal address book. The subscriber can enter the alias using either spoken commands or DTMF tones. In another embodiment, a recipient's phone number can be used. The system 100 calls the phone number and when the recipient answers, the system 100 plays the audio content that has been forwarded. Unlike voice mail that is limited to phone numbers connected to that voice mail server, the web telephone system 100 can call any phone number that the subscriber inputs, as it is connected to the PSTN. Additionally, the system 100 can determine if the phone number of the recipient subscribes to a short message service (SMS). If the recipient does use SMS, the system can leave a phone number for the recipient to call back. When the recipient does call back, the system 100 recognizes, via the phone number of the caller, that the caller is a recipient of forwarded audio content. The system plays that forwarded audio content to the caller. Recognizing that the caller is not a subscriber, the system 100 can also play selected advertisements to the caller. In one embodiment, these advertisements can be associated with the system 100 or with the forwarded audio content. By having the caller call back the system 100, the caller is given the opportunity of listening to the forwarded audio content when it is convenient for the caller.

After the subscriber has entered a recipient, the system 100 determines whether the subscriber wants to forward the audio content to another recipient (step 450). For example, the system 100 can ask the subscriber if he or she wishes to enter another recipient and wait for the subscriber to reply. If the subscriber does have another recipient, the subscriber inputs the email address, alias, or phone number (step 445). These steps (step 445, step 450) continue until the subscriber has inputted all of the desired recipients.

For those recipients whose address was entered as an email address, the system 100 constructs an audio email message from the subscriber. It is not important whether the recipient is or is not a subscriber to the system. The recipient only needs to have an email address. The concept of audio content forwarding is most similar to the concept of forwarding a link from a web browser. The created audio email message includes the reference pointer (e.g., a URL) to the audio content to which the subscriber was listening. The system sends the audio email message to all of the recipients that the subscriber has input into the system (step 455).

If the recipient is a subscriber, then the recipient can hear the content when retrieving recipient's messages from the telephone interface. If the recipient is not a subscriber, then the recipient can hear the content when the recipient retrieves the audio email message from their email client (e.g., Outlook) or via their Webmail client (e.g., Hotmail). The recipient clicks on the reference pointer (e.g., URL) to hear the content (assuming they are using a multimedia PC). In one embodiment, when the recipient accesses the audio content on the system's web server 132′, the system 100 can attach advertising to the audio content. The advertising may be from the system, trying to obtain another subscriber. The advertising can also be from a third party, perhaps affiliated in some way with the audio content being accessed.

Though the example used describes audio content being forwarded, the invention is not limited to audio content. Any format of content that is available to the subscriber on the system can be forwarded. For example, the subscriber can be listening to a text email, using a text to speech module 162b, and decide to forward that text email either as a text file or an audio file to which the recipient listens.

Another embodiment of the process includes a step where the subscriber adds an introductory comment to the audio content. This introductory comment can be stored as a separate file. In one embodiment, the audio email message sent to the recipient contains two reference pointers. One is for the audio content forwarded, the other is for the introductory message. If the audio content is forwarded to a phone number and the recipient is receiving the audio content using a phone, the system 100 plays the introductory comment prior to playing the forwarded audio content. Alternatively, there can be one reference pointer that points to both the audio content forwarded and the introductory message. In another embodiment, a file can be transferred that has links embedded in the file. For example, a Real Audio Media file (.RAM) is a file executed by a multimedia player application 162a (e.g., RealPlayer). As the application is executing the file, the application goes to the URLs of the reference pointers embedded in the file, retrieves the audio information and plays the information retrieved from each URL.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for retrieving an audio application attachment to an electronic mail message (“email”), the method comprising:
establishing a telephone call with a user connecting to an audio web telephone system using a telephony device;
processing a command from the user to enable the user to retrieve an email from a buffer location accessible to the audio web telephone system;
detecting an audio application attachment to the email;
passing the audio application attachment to an audio browser;
executing the audio application attachment by processing Voice XML code within the audio application attachment and generating an audio message; and
providing the audio message to the user via the telephony device.

2. The method of claim 1 further comprising identifying a sender of the email having the audio application attachment prior to executing the Voice XML statements of the attachment.

3. The method of claim 2 wherein the step of identifying further comprises reviewing a list of senders.

4. The method of claim 1 further comprising requesting the user's permission prior to executing the audio application attachment.

5. The method of claim 1 further comprising providing a profile of the user to a sender of the email.

6. The method of claim 1 wherein the step of establishing a phone call further comprises:
receiving a circuit-switched signal from the telephony device used by the user over a public switched telephone network (“PSTN”);
converting the circuit-switched signal to a telephony packet protocol signal including an audio portion;
converting the telephony packet protocol signal to an Internet protocol (“IP”) packet signal including an audio portion;
converting the audio portion of the IP packet signal to a text equivalent signal; and
converting the text equivalent signal to an IP network command signal.

7. The method of claim 1 wherein the step of establishing further comprises originating, by the user a phone call to the audio web telephone system.

8. The method of claim 1 wherein the step of establishing further comprises originating, by the audio web telephone system a phone call to the user.

9. A method of retrieving an audio application attachment from a web-based document, the method comprising:
establishing a telephone call with a user of an audio web telephone system using a telephony device to request access to a web-based document;
determining an audio application attachment to the web-based document;
transmitting the audio application attachment to an audio browser;
executing the audio application attachment by processing the Voice XML code within the audio application and generating an audio message; and
providing the audio message to the user via the telephony device.

10. The method of claim 9 wherein the step of establishing a phone call further comprises:
receiving a circuit-switched signal from a telephony device used by the user over a public switched telephone network (“PSTN”);
converting the circuit-switched signal to a telephony packet protocol signal including an audio portion;
converting the telephony packet protocol signal to an Internet protocol (“IP”) packet signal including an audio portion;
converting the audio portion of the IP packet signal to a text equivalent signal; and
converting the text equivalent signal to an IP network command signal.

11. The method of claim 9 wherein the step of establishing further comprises originating, by the user a phone call to the audio web telephone system.

12. The method of claim 9 wherein the step of establishing further comprises originating, by the audio web telephone system a phone call to the user.

13. An audio web telephone system for retrieving an audio application attachment from an electronic mail message (“email”) or from a web-based document, the system comprising:
a telephony gateway in communication with a public switched telephone network (“PSTN”), the telephony gateway configured to receive a telephone call from a user using a telephony device;
an Internet protocol (“IP”) network; and
an audio browser comprising:
a content retrieval module in communication with the IP network, the content retrieval module configured to detect an audio application attachment from one of an email and a web-based document;
a VXML browser in communication with the IP network, the VXML browser configured to execute the audio application attachment by processing Voice XML code within the audio application attachment and generating an audio message; and
a telephony interface module in communication with the telephony gateway for communicating with a telephony device of the user and in communication with an IP network to receive the audio message, the telephony interface configured to translate an IP based signal of the audio message to a telephony packet-based signal of the audio message, thereby providing the audio message to the user via the telephony device.

14. The system of claim 13 further comprising an authentication module in communication with the IP network, the authentication module having a list of trusted senders.

15. The system of claim 13 further comprising web cache.

16. The system of claim 13 wherein the audio browser further comprises a navigation module.

17. The system of claim 16 wherein the navigation module further comprises one of speech recognition module and touch tone (DTMF) recognition module.

18. The system of claim 13 wherein the content retrieval module further comprises one of text-to-speech module and streaming media module.
